(19) United States
(12) Patent Application Publication
(10) Pub. No.: US 2010/0258531 A1
(43) Pub. Date: Oct. 14, 2010

(54) ARC CHAMBER FOR A SWITCHING DEVICE, AND SWITCHING DEVICE COMPRISING SAID ARC CHAMBER

(75) Inventors: Nicola Bresciani, Bergamo (IT); Andrea Balestrero, Bergamo (IT)

Correspondence Address: CONNOLLY BOVE LODGE & HUTZ LLP, 1875 EYE STREET, N.W., SUITE 1100, WASHINGTON, DC, 20006, US

(73) Assignee: ABB S.p.A., Milano (IT)

(21) Appl. No.: 12/741,614

(22) PCT Filed: Oct. 28, 2008
(86) PCT No.: PCT/EP2008/064613

§ 371 Date: May 6, 2010

(30) Foreign Application Priority Data
Nov. 21, 2007 (IT) MI2007A002202

(51) Int. Cl. H01H 9/36

(52) U.S. Cl. 218/151

(57) ABSTRACT

The present invention relates to an arc chamber for a switching device, in particular a circuit breaker, a disconnector or a contactor, with a high interruption power, to be used preferably in low-voltage electrical systems. The arc chamber according to the invention comprises a plurality of substantially U-shaped metal plates and a casing made of electrically insulating material provided with opposed internal grooves for insertion of said metal plates. The arc chamber moreover comprises one or more polar expansions housed in corresponding containment seats arranged within the casing. Each of said containment seats is configured in such a way as to insulate the polar expansions from the metal plates. The invention likewise relates to a switching device comprising said arc chamber.

The present invention relates to an arc chamber for a switching device, in particular a circuit breaker, a disconnector, or a contactor, with a high interruption power, to be used preferably in low-voltage electrical systems. The invention likewise relates to a switching device comprising said arc chamber.

It is known that switching devices (such as for example circuit breakers, disconnectors, contactors, limiters), universally known also as “switching devices” and hereinafter referred to, for reasons of brevity, as switches, comprise a casing, one or more electrical poles, associated to each of which is at least one pair of contacts that can be coupled to and uncoupled from one another. Switches of the known art also comprise control means that cause relative movement of said pairs of contacts so that they can assume at least one first, coupling, position (circuit closed) and one second, separation, position (circuit open).

Generally associated to each pole of the switch is at least one arc chamber, i.e., a region of space rendered particularly suited to favouring electric-arc interruption. Arc chambers can be simple regions provided in the casing of the switch, or else can comprise various modular elements shaped, for example, like casings made of insulating material equipped with arc-breaking plates. Modular arc chambers, which are more advanced, present the advantage of being easily replaceable and of being realizeable with materials that are more suitable as compared, for example, to the ones used for the casing of the switch.

Generally, the pairs of contacts that can be coupled to and uncoupled from one another are made up of first, substantially fixed, elements (the fixed contacts) and second, mobile, elements (the mobile contacts). The control means comprise, instead, mechanisms, which terminate, for example, in a main shaft operatively connected to said mobile contacts.

There exist solutions (such as, for example, the one described in the patent application No. WO2006120149) in which the main shaft and the mobile contacts are integrated in a single member, the so-called rotating moving element. Said member, which is made of insulating material, must guarantee both electrical insulation between the phases and, of course, proper transmission of the movements to the mobile contacts, as well as being able to withstand the forces involved. Switches of this type present considerable advantages, such as for example a limited number of parts and limited overall dimensions. The shaft or moving element are usually connected to the casing of the switch via bearings.

In switches with a main shaft of a traditional type, the mobile contacts are divided between different mobile supports, corresponding to each pole. In switches with moving element, the mobile contacts are instead mounted in purposely provided openings made in the moving element itself.

As is known, during the service life of a switch, there may arise phenomena that expose the switch and the network to particularly high stresses. This occurs in the first place when the switch is required to support, albeit for a short time, currents higher than the nominal values. The time during which the switch and the electrical network are exposed to an overcurrent (for example, an overload or a short circuit), depends upon the natural duration of the episode, or, with greater likelihood, upon the time necessary for the protection devices to set the switch effectively in conditions of safety, i.e., to interrupt the overcurrent. Interruption of an overcurrent is a complex phenomenon. In technical terms, the capacity of the switch for interrupting currents of a given level is defined as interruption power. The capacity of the switch to withstand for short periods currents that are much higher than the nominal current is instead defined as “electrodynamic strength”.

The energy that flows and is dissipated in the switch and in the electrical network during an episode of overcurrent tends to cause damage, which depends both upon the intensity of the current and upon the duration of the phenomenon, up to complete interruption of the fault current. The most common damage may consist in early decay of the characteristics of the components exposed and hence degradation of the performance of the switch itself and of the electrical network. In some cases, the high temperatures involved may even lead to flashes.

As is known, in order to limit the occurrence of damage both to the electrical network and to the switch itself or to its parts (contact plates, arc-extinction chamber, control, insulating elements), many solutions have been tested and developed to render circuit breaking as fast and effective as possible. The various solutions envisage, for example, the use of adequate control springs and materials suitable for withstanding stresses and high temperatures.

Other solutions envisage the use of gasifying means and/or materials, capable of releasing extinguishing substances in the proximity of the area of formation of the electric arc; said means and/or materials are typically stimulated by the temperature reached when an electric arc occurs. An example of these solutions is illustrated in the patent application No. WO0150488.

Yet other solutions tend to exploit advantageously or else control in various ways the electromagnetic phenomena that develop in the area of formation and interruption of the electric arc. Solutions of this type are described, for example, in the patent applications Nos. EP0887832 and EP0567614.

All these solutions have in common the use of ferromagnetic elements of various kind and shape. Said ferromagnetic elements, that can be assimilated to polar expansions, have the principal function of attracting the mobile contacts towards the opening position by the electromagnetic effect, thus contributing to rapid interruption of the electric arc. The polar expansions are fixed directly or indirectly on the internal surfaces of the switch usually in a position adjacent to the arc chamber so that the region in which decoupling of the contacts (i.e., of the mobile contact with respect to the fixed contact) occurs advantageously feels said electromagnetic effects.

Even though these solutions are relatively effective from the functional standpoint, they present certain drawbacks linked in particular to the positioning of the polar expansions in the switch. Currently, in fact, said operation proves particularly critical in so far as possible defects can result in risks of short-circuiting, malfunctioning or failure of the switch to open. In this connection, in current solutions not infrequently the polar expansions prove to be a cause of poor reliability and stability of operation of the switch. In fact, their usual positioning in the majority of cases has a negative effect on the other characteristics of the switch.

From the constructional standpoint, it may moreover be noted that the polar expansions currently used appear somewhat cumbersome, frequently resembling large transformers located within the switch in a position close to the area of junction between the contacts. It is clear that the presence of a mass of metal material in this position creates further problems linked in particular to the need to insulate said mass from the rest of the switch. Is has moreover been noted that the position occupied currently by the polar expansions can disadvantageously determine also a degradation of the functions of the switch, such as, for example, the insulation between the phases or the reliability of the mechanical functions. Said episodes of malfunctioning can be caused by obstructions accumulated by the polar expansions following upon recall and deposit of metal particles that have evaporated or sublimated as a result of short-circuiting phenomena.

On the basis of the above considerations, there is a need to have available alternative technical solutions that will enable the limits and the problems set forth above to be overcome. Consequently, the task of what forms the subject of the present invention is to provide a switching device that will enable said drawbacks to be solved.

In the framework of this task, a purpose of the present invention is to provide a switching device equipped with polar expansions that can be easily assembled with the other parts making up the device itself.

Another purpose of the present invention is to provide a switching device equipped with polar expansions, positioning of which will not have a negative effect on the characteristics of the switching device.

Yet a further purpose of the present invention is to provide a switching device equipped with polar expansions, the overall dimensions of which will be as contained as possible and the configuration of which will enable easy insulation from the other parts making up the switching device.

Not the least important purpose of what forms the subject of the present invention is to provide a switching device that is reliable and relatively easy to produce at competitive costs.

The above task, as well as the above and other purposes that will appear more clearly in the course of the ensuing description are achieved with an arc chamber comprising a plurality of substantially U-shaped metal plates and a casing made of insulating material provided with opposed internal grooves for insertion of the metal plates. The arc chamber according to the invention is characterized in that it comprises one or more polar expansions housed in corresponding containment seats arranged within the casing. Each of said containment seats is configured in such a way as to insulate electrically the polar expansions from the metal plates.

The main advantage of the arc chamber according to the invention is identified clearly in the fact of englobing, in the modular structure of the arc chamber, the polar expansions provided for accelerating opening between the contacts of the switch that will be governed by the chamber itself. Through this solution, in fact, the times for assembly and maintenance are considerably reduced precisely because the modularity of the arc chamber is exploited for positioning and removing the polar expansions. Said modularity can be advantageously exploited also for improving the performance of switches the initial configuration of which does not envisage the use of polar expansions. In other words, it is possible to replace the arc chamber of a traditional switch with an arc chamber that is structurally compatible, but is moreover provided with polar expansions according to the principles of the present invention.

Further characteristics and advantages will emerge more clearly from the description of preferred, but not exclusive, embodiments of the arc chamber according to the present invention, illustrated by way of non-limiting example in the attached drawings, where:

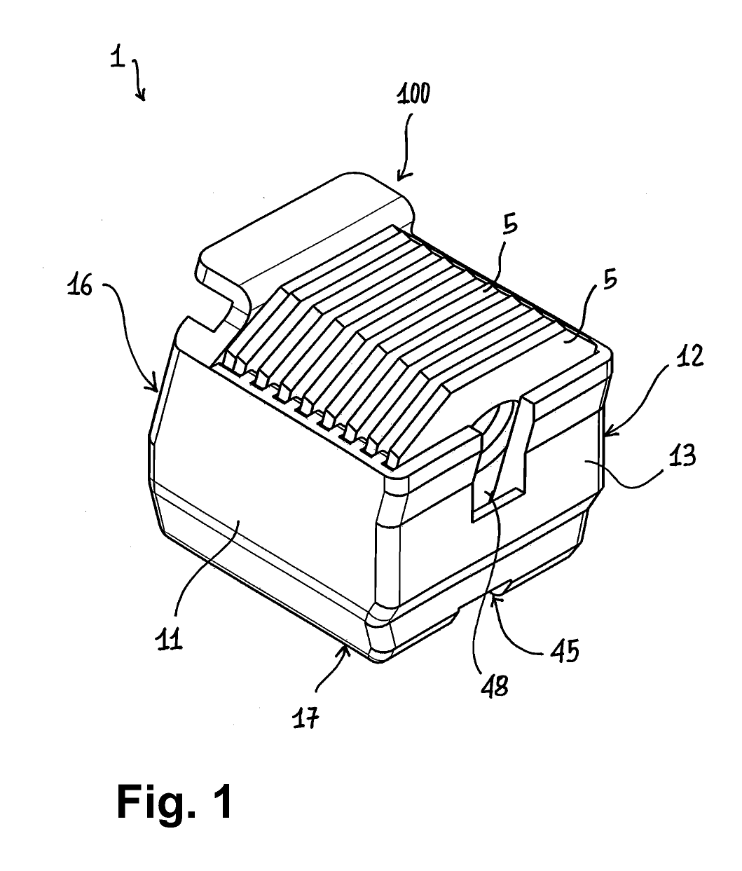

FIG. 1 is a perspective view of a first embodiment of an arc chamber according to the invention;

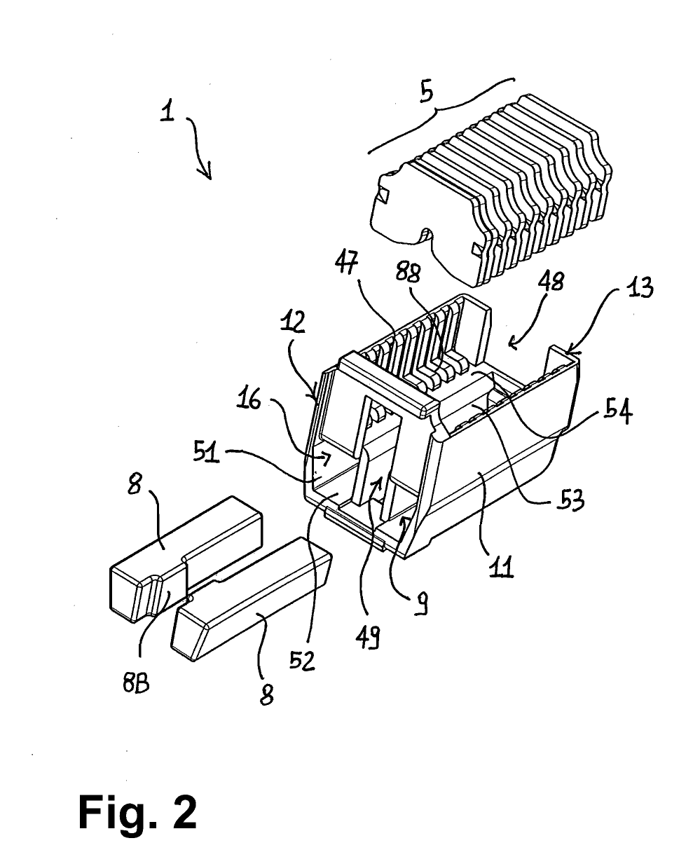

FIG. 2 is an exploded view of a generic arc chamber according to the invention;

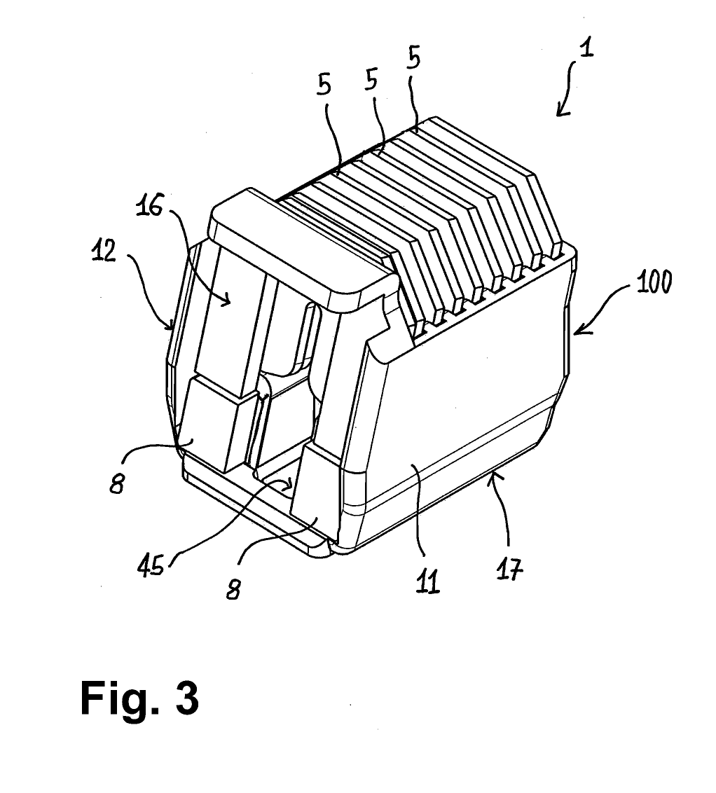

FIG. 3 is a perspective view of a second embodiment of an arc chamber according to the invention;

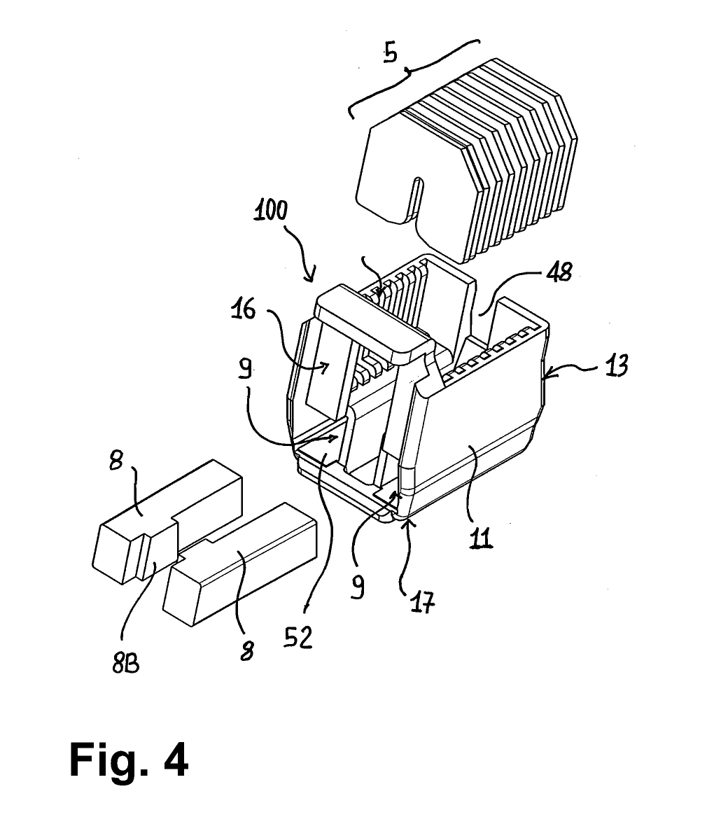

FIG. 4 is an exploded view of the arc chamber of FIG. 3;

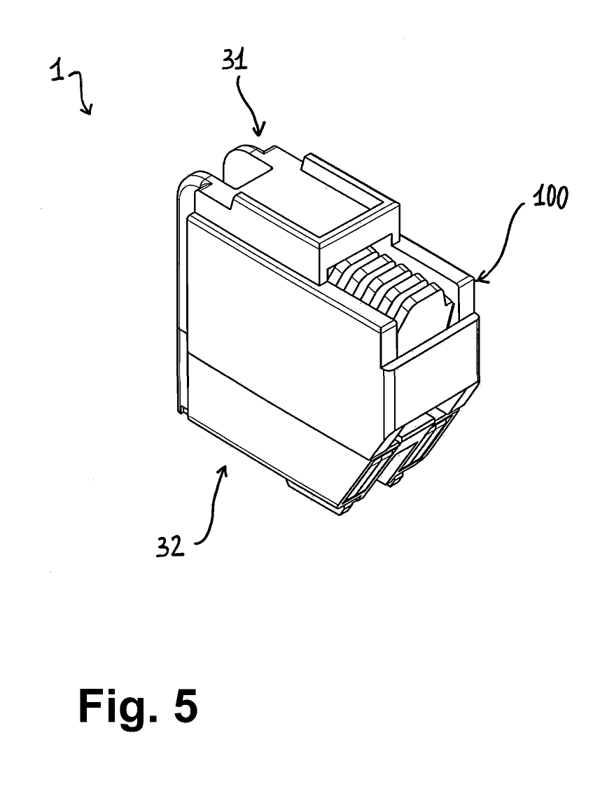

FIG. 5 is a perspective view of a third embodiment of an arc chamber according to the invention;

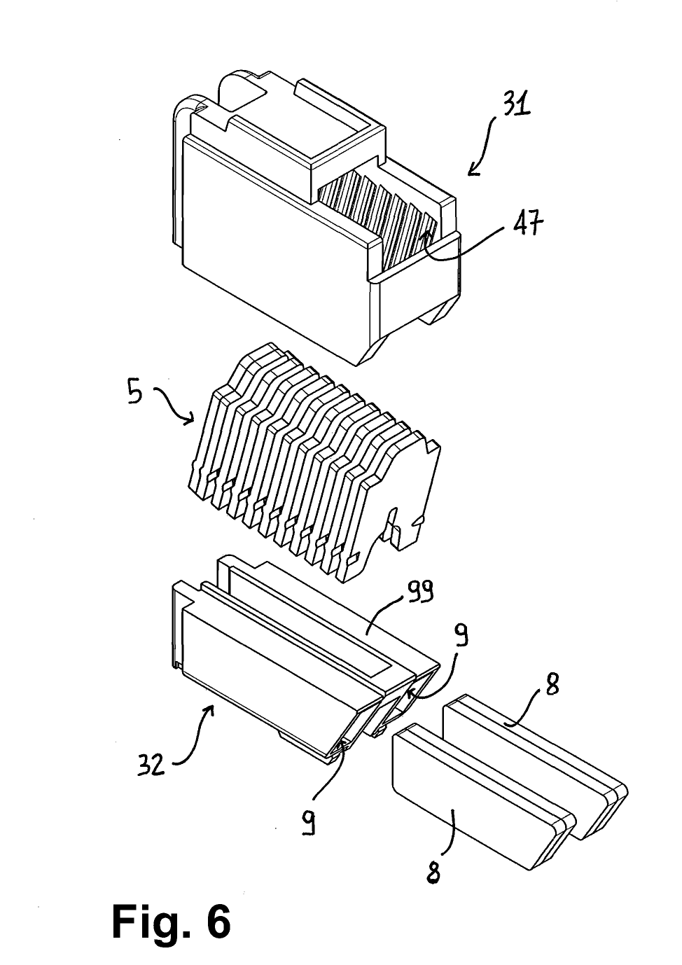

FIG. 6 is an exploded view of the arc chamber of FIG. 5;

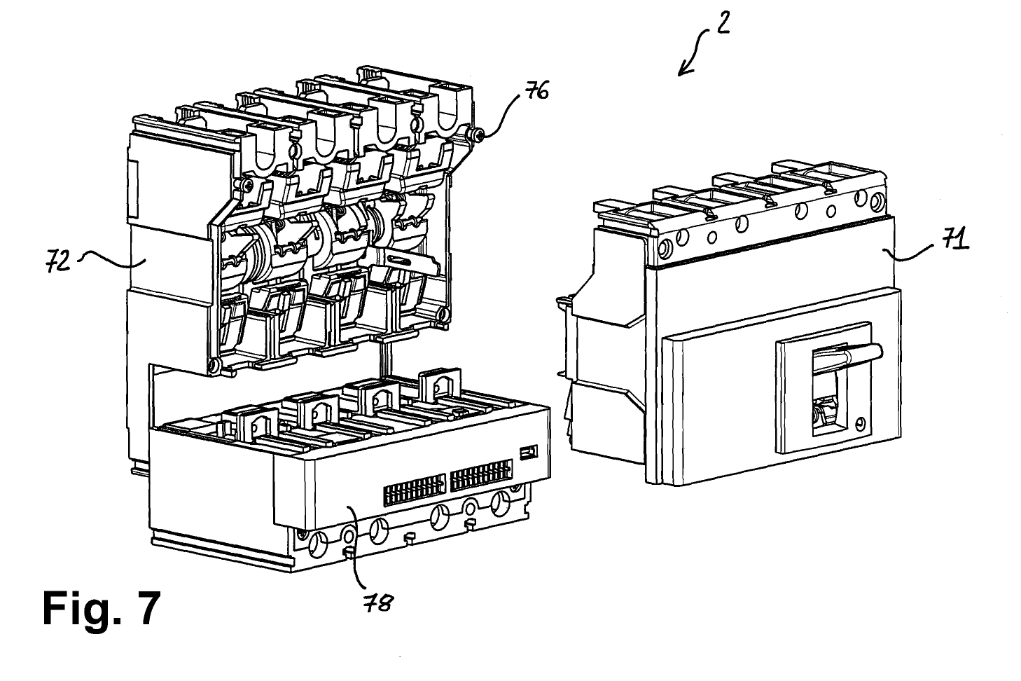

FIG. 7 is a first perspective view in exploded configuration of a switching device comprising at least one arc chamber according to the invention;

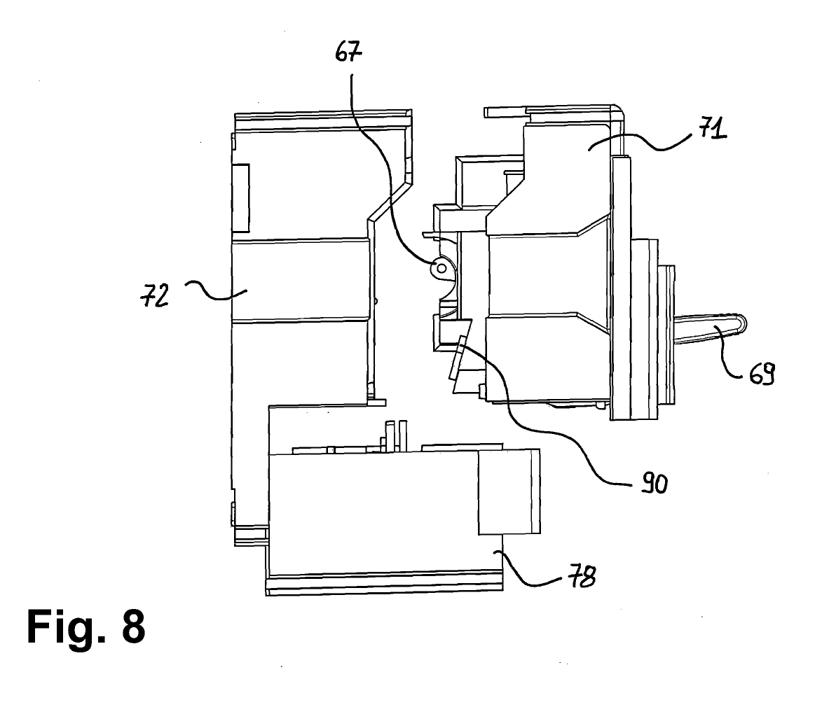

FIG. 8 is a first exploded view in side elevation of the switching device of FIG. 7; and

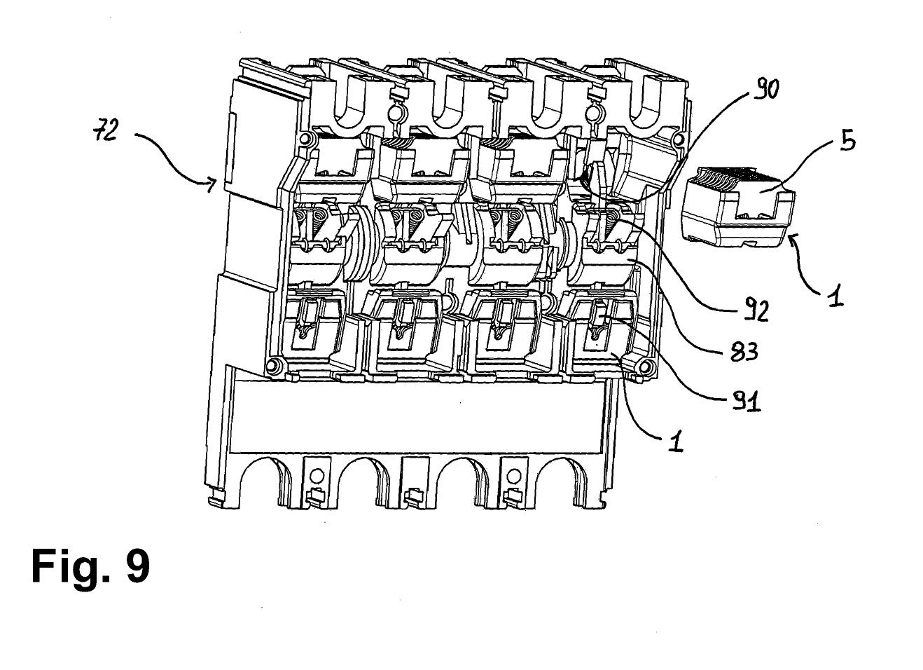

FIGS. 9 to 11 are perspective views of parts of the switching device illustrated in FIGS. 7 and 8.

With reference to the above figures, the arc chamber 1 according to the invention comprises a plurality of substantially U-shaped metal plates 5, which are housed within a casing 100 made of, preferably gasifying, electrically insulating material. The arc chamber 1 according to the invention is characterized in that it comprises at least one pair of polar expansions 8 housed in corresponding containment seats 9 defined within the casing 100. Each containment seat 9 is configured in such a way as to insulate, from an electrical standpoint, the corresponding polar expansion 8 from the metal plates 5.

Unlike the traditional technical solutions, according to the present invention the polar expansions 8 are hence integrated in the structure of the arc chamber 1. Once the arc chamber 1 is assembled on a switching device, the polar expansions 8 are located in their operative position without the need for further operations of assembly. Obviously this aspect results in an advantageous reduction of the times for assembly and hence of the final costs of construction of the device 2. The use of appropriately shaped containment seats 9 moreover enables electrical insulation of the polar expansions 8, simplifying in a determining way the design of the switch, which in the majority of the cases is complicated by the need to provide appropriate insulation structures.

FIG. 1 relates to a first embodiment of the arc chamber 1 according to the invention in which the containment casing 100 comprises two opposed side walls 11, 12, which develop in a longitudinal direction so as to bestow upon the casing 100 a substantially prismatic configuration. A front wall 13 and a rear wall 16, opposite to the front one, delimit the casing 100 longitudinally. The front wall 13 comprises a first opening 48, the function of which is to enable relief of the gases that develop within the arc chamber 1 as a result of the electrical arc deriving from the separation of the contacts of the switching device 2. The rear wall 16 comprises a second opening 49 (see FIG. 2) in the position of coupling of the mobile contact 91 of a pole of the switching device 2 with the corresponding fixed contact 90.

The casing 100 also comprises a bottom wall 17, which is provided with a longitudinal opening 45, which defines a space for movement for the mobile contact 91 of the switching device 2. The containment seats 9 develop longitudinally on opposite sides of said longitudinal opening 45. From FIG. 1 it may be noted that this technical solution in other words enables having available, without risks, the polar expansions 8 in a position immediately adjacent to the space of movement of the mobile contact 91. It is evident that, as a result of this technical solution, the overall dimensions corresponding to the polar expansions 8 are contained in the structure of the casing 100 of the arc chamber 1. At the same time, the polar expansions 8 advantageously assume the position most suitable for performing their function.

Thanks to their positioning close to the area of junction of the contacts, the polar expansions can present relatively contained overall dimensions and can be advantageously made using reduced amounts of material. The latter can moreover be of lower quality with respect to the ones traditionally used for the same purpose. In fact, in traditional solutions the large amount of material and its high quality (accompanied by a high cost) must precisely make up for the position of the polar expansions that is relatively distant from said area of junction of the contacts.

Materials for the polar expansions suitable for the purposes of the present invention have been found to be, for example, low-carbon (rolled or sintered) steels, passivated pure iron, and plastic-bonded magnets (PBMs). For d.c. applications, very good results can be obtained using permanent magnets.

FIG. 2 is an exploded view of the arc chamber 1 of FIG. 1, which shows a preferred embodiment of the containment seats 9. The latter have a substantially prismatic configuration that develops starting from apertures made in the rear wall 16 of the casing 100, and terminates in a position corresponding to the front wall 13. In practice, in this solution, the containment seats 9 develop substantially throughout the length of the longitudinal opening 45 provided along the bottom wall 17. Alternatively, they could develop for a more limited longitudinal stretch, for example for those applications in which there is sufficient a less marked effect of acceleration of the mobile contact 91.

As may be seen in the exploded view of FIG. 2, the polar expansions 8 have a configuration geometrically corresponding to that of the seats 9 in which they are inserted. By the expression “configuration geometrically corresponding” is basically meant a correspondence in geometrical terms between the longitudinal sides of the polar expansions and those of the corresponding containment seats.

According to a preferred embodiment, said expansions 8 have at least one transverse thickened portion 8B in order to optimize the technical effect of acceleration of the mobile contact towards the open position. In detail, said thickened portion is defined in a position corresponding to a portion which in service (i.e., when the expansion 8 is inserted in the corresponding seat 9) sets itself in a position close to the rear opening 49 of the rear wall 16. In this way, once the arc chamber 1 is installed in the switching device 2, the transverse thickened portion 8B is located in a position close to the area of junction of the contacts 90, 91 so as to accelerate repulsion thereof, above all at the start of the separation step.

According to a preferred embodiment of the invention, each containment seat 9 comprises a first wall 51 defined by a first portion of an inner side of one of the side walls 11, 12 that form the casing 100. As illustrated in FIG. 2, said first portion proves contiguous to a second portion, on which the grooves 47 for insertion of the metal plates 5 are provided.

The containment seats 9 are moreover delimited by a second wall 52, defined by an inner side of the bottom wall 17 of the casing 100, and by a third wall 53, opposite to the first wall 51, which develops along the longitudinal edges of the longitudinal opening 45 of the bottom wall 17 of the casing 100. The structure of the containment seats 9 is completed by a fourth wall 54, opposite to the second wall 52, which develops transversely with respect to the first wall 51 and to the third wall 53.

Through the technical solution just described, there is advantageously exploited the external structure of the casing 100 for defining the containment seats 9. From the practical standpoint, this enables the seats 9 to be made of a single piece with the casing 100, for example through an injection-moulding process. The costs of production can thus be advantageously reduced. The possible use of gasifying material also for the production of the seats further favours the process of extinction of the electric arc.

Falling in any case within the framework of the present invention is the possibility of providing the containment seats 9 and the structure of the casing 100 separately, by providing appropriate coupling means. On this assumption, for example, the containment seats 9 could be defined by hollow prismatic profiles, in which the polar expansions 8 are housed. Said profiles could be subsequently inserted within the casing 100 exploiting coupling elements provided on the external surface of the hollow profiles and on the internal surfaces of the walls 11, 12 and 17 that delimit the casing 100 longitudinally. Once again on this assumption, the casing 100 could be open at the bottom, i.e., without the aforesaid bottom wall 17. Once in fact the hollow profiles were to be inserted in the casing 100, a side thereof could define a wall constructionally corresponding to the bottom wall 17 provided in the “single-piece” solution.

According to a further embodiment, illustrated for example in FIGS. 5 and 6, the arc chamber 1 can comprise a casing 100 comprising a plurality of portions 31, 32, which can be made separately and which fit together in regions corresponding to coupling surfaces 99. Recourse to arc chambers made up of a number of portions can be suggested, for example, by production requirements dictated by the shape and constructional characteristics of the switches and of the arc chambers.

In detail, in the solution illustrated, the casing 100 comprises a top portion 31 and a bottom portion 32. The top portion 31 defines the opposed grooves 47 for insertion of the metal plates 5 and is open at the bottom to enable insertion of the metal plates 5. The bottom portion 32 defines, instead, two containment seats 9 each for housing a polar expansion 8. Said seats 9 are configured so as to result longitudinally parallel. The fitting together of the two portions 31 and 32 configures as a whole a casing conceptually equivalent to the one illustrated in FIGS. 1 to 5. It has been seen that the solution in question is particularly effective for an arc chamber 1 for a switching device 2 of a size that is relatively contained with respect to the two previous solutions.

According to a preferred embodiment of the invention, provided on the outside of the containment seats 9 is a surface with recesses 88, each of which is geometrically aligned to one of the grooves 47 designed for supporting the metal plates 5. With reference, for example, to what is illustrated in FIG. 2, in a position corresponding to the outer side of the fourth wall 54 of each containment seat 9 a plurality of recesses 88 are provided, each of which is aligned with a groove 47 defined on the inner side of the side wall 11 or 12 adjacent to the wall itself. This solution advantageously enables a more stable and secure positioning of the metal plates 5 within the casing 100.

FIGS. 3 and 4 regard a further embodiment of the arc chamber 1 that differs from the ones previously described on account of the different configuration of the casing 100. More precisely, said arc chamber 1 is designed to govern a switching device 2 of a size different from that for which the arc chambers 1 illustrated in FIGS. 1, 2, 5 and 6 are designed.

The outer side of the side walls of the casing 100 is shaped in such a way as to be geometrically mated to housing cavities 70 present in the structure of the switch 2 for receiving the arc chamber 1 itself. In particular, the side walls 11 and 12 of the casing 100 comprise longitudinal portions profiled so as to be geometrically mated to corresponding coupling portions 75, 76 defined by the surfaces of said housing cavity 70. In the same way, the front wall 13 and the rear wall 16 are profiled so as to constitute corresponding “contrast surfaces” bearing upon walls of the switch 2 so as to block the arc chamber axially once it is set inside the housing cavity 70.

The present invention also relates to a switching device 2 comprising an external casing, at least one pair of contacts 90, 91 that can be coupled to and uncoupled from one another, a control device 67 for breaking and making said at least one pair of contacts 90, 91, and a protection device 78 for activation of said control device 67. The switching device 2 is characterized in that it comprises an arc chamber 1 according to the present invention.

In this connection, FIGS. 7 to 11 refer to a possible embodiment of a switching device 2 according to the invention, and more precisely regard a double-breaking switch for low-voltage systems. The switch illustrated is of the four-pole double-breaking type and comprises for each pole two mobile contacts and two corresponding fixed contacts. It is obviously to be understood that the principles and the technical solutions set forth in the framework of the description of the inventive idea remain valid also for single-breaking switches with one or more poles.

The external casing of the device 2 illustrated is formed by a first shell 71 and a second shell 72, which fit together through removable connection means 76, such as may for example be tap screws. The protection device 78, comprises, for example, an electronic relay operatively connected to the control device 67 housed in the first shell 71. The control device 67 can be actuated by the protection device 78 (for example, following upon a short-circuiting phenomenon) or alternatively, by a user by means of a corresponding maneuvering lever 69.

With reference in particular to FIG. 9, the control device 67 is operatively connected to a moving element 83, on which the mobile contacts 91 are mounted. Said moving element is rotatably mounted within the second shell 72 so as to turn between two positions characteristic of a condition of device 2 open and closed, respectively. According to known modalities of construction, the mobile contacts 91 are subjected to the action of elastic means 92 that ensure proper contact pressure.

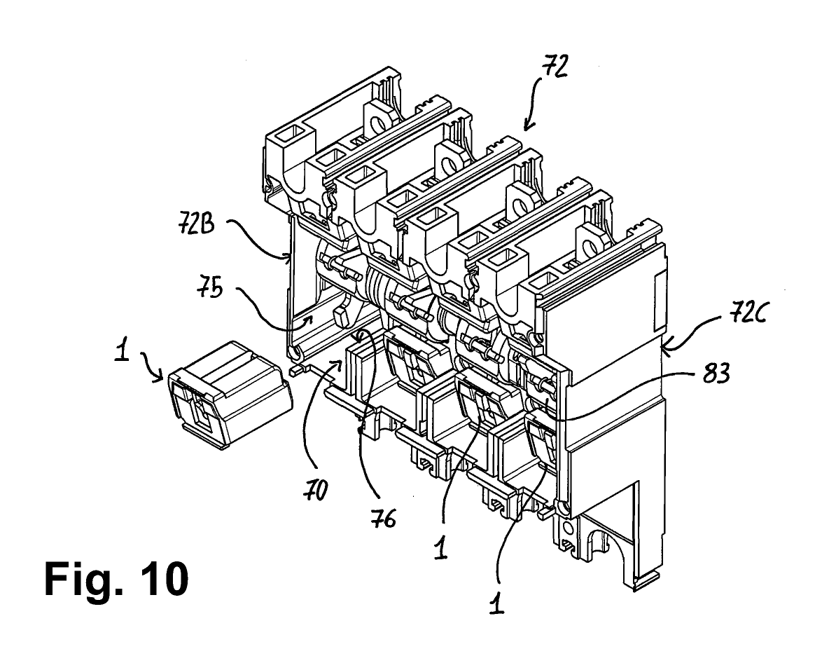

FIG. 10 is a perspective view that illustrates in detail the structure of the second shell 72. In particular, it may be noted that, for each pole of the switch, two housing cavities 70 are provided, at least one of which, (preferably both) is designed to house an arc chamber 1 according to the present invention. Each cavity has a substantially prismatic configuration defined by a pair of mutually opposed side surfaces 75, 76 that have a geometrical profile mated to that of the outer side of the side walls 11, 12 of the arc chamber according to the invention. In greater detail, the side surfaces 75, 76 develop in a direction substantially orthogonal to the axis of rotation of the moving element 83 so that insertion of the arc chamber 1 is made in the same direction.

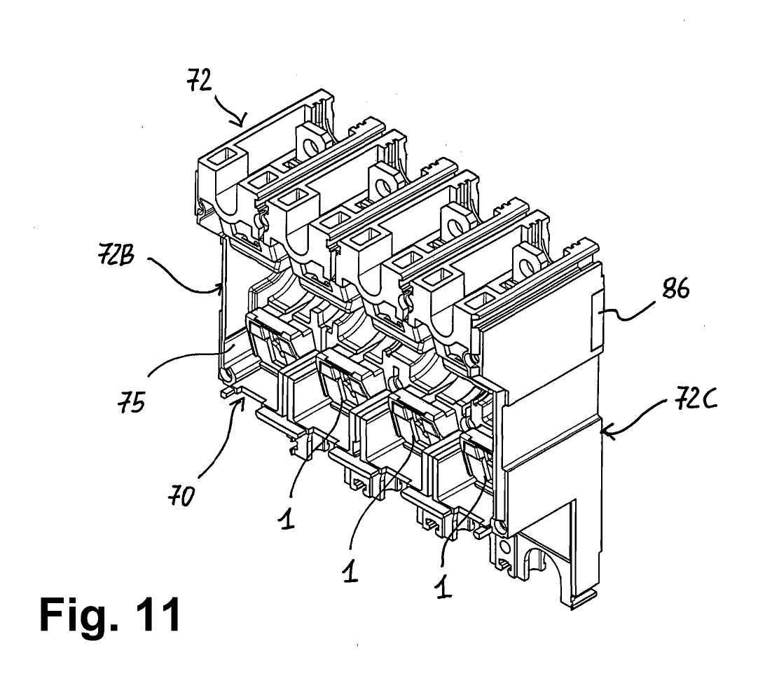

Adopting this solution, the side surfaces 75, 76 of the cavity 70 guide insertion of the arc chamber 1 within the cavity itself, providing a stable coupling between the parts as may be appreciated from FIGS. 10 and 11. In said figures, another advantageous characteristic of the switch according to the present invention may be noted. It may be noted in fact that for each pole the two corresponding housing cavities 70 are provided in positions opposite to the axis of rotation of the moving element 83. In this connection, the housing cavities 70 are set in such a way as to enable, possibly, insertion of arc chambers 1 on opposed sides of the second shell 72. In this case, a first arc chamber would be inserted on a first side 72B of the second shell 72 designed to couple with a corresponding side of the first shell 71, whilst a second arc chamber would be inserted in the corresponding cavity 70 through an access aperture defined on a second side 72C opposite to the first side 72B.

As is evident from FIG. 9, the second side 72C of the second shell 72 constitutes in practice a side of the external casing of the device 2 once the two shells 71, 72 are assembled. In this connection, in the figure illustrated, provided on the second side of the second shell 72C is a removable covering element 86, which closes access to the arc chamber 1 during normal operation of the switching device 2. Said element 86 can be advantageously removed in order to enable operations of inspection, maintenance and/or replacement of the arc chamber 1 and consequently of the polar expansions 8 located therein.

It is evident that this technical solution is somewhat advantageous in so far as it enables, for example, extraction of the arc chamber 1, by removing just the covering element 86 without requiring further interventions on the structure of the switching device 2. The maintenance operations and the corresponding costs can in this way be sensibly reduced.

The technical solutions adopted for the arc chamber and for the switching device according to the invention enable the pre-set task and purposes to be fully achieved. In particular, the positioning of the polar expansions within the casing of the arc chamber enables easy assembly of the switching device, moreover simplifying the corresponding maintenance operations. This technical solution further enables location of the polar expansions in the position most suitable for their operation, thus drastically limiting the corresponding overall dimensions.

The arc chamber and the switching device thus conceived may undergo numerous modifications and variations, all of which fall within the framework of the inventive idea; in addition, all the items may be constituted by other technically equivalent ones.

In practice, the materials used, as well as the contingent dimensions and shapes, may be any whatsoever according to the requirements and the state of the art.

1. An arc chamber for a low-voltage switch, comprising:
a plurality of substantially U-shaped metal plates; and
a casing made of electrically insulating material provided with opposed internal grooves for insertion of said metal plates,
said arc chamber being characterized in that it comprises one or more polar expansions housed in corresponding containment seats arranged within said casing, each of said containment seats being configured in such a way as to insulate said polar expansions from said metal plates.

2. The arc chamber according to claim 1, wherein said casing comprises two opposed side walls, which develop longitudinally between a front wall and a rear wall, said side walls being internally configured in such a way as to define said internal grooves, said front wall and said rear wall each comprising at least one opening, said casing comprising at least one bottom wall provided with a longitudinal opening, said arc chamber comprising a pair of containment seats mutually opposed with respect to said longitudinal opening.

3. The arc chamber according to claim 2, wherein each of said containment seats has a prismatic configuration and develops starting from said rear wall of said casing.

4. The arc chamber according to claim 3, wherein in that each of said containment seats comprises a first wall defined by the inner side of one of said side walls of said casing, each of said containment seats comprising a second wall defined by the inner side of said bottom wall of said casing.

5. The arc chamber according to claim 4, wherein each of said containment seats comprises a third wall opposite to said first wall, which develops along a longitudinal edge of said longitudinal opening of said bottom wall, each of said containment seats comprising a fourth wall opposite to said second wall.

6. The arc chamber according to claim 5, wherein said fourth wall comprises an external surface, provided in which is a plurality of recesses, each of which is aligned with one of said grooves.

7. The arc chamber according to claim 1, wherein said containment seats are made of a single piece with said casing.

8. The arc chamber according to claim 1, wherein said casing is made of a number of portions that can be coupled together at corresponding coupling surfaces.

9. The arc chamber according to claim 8, wherein said casing comprises a top portion and a bottom portion, said top portion defining internally on opposite sides said opposed grooves and being open at the bottom, said bottom portion defining said containment seats for said polar expansions.

10. The arc chamber according to claim 1, wherein said polar expansions have a prismatic shape provided with a transverse thickened portion defined in the proximity of a portion that is located, following upon installation of said arc chamber in said switching device, in a position close to said second opening of said rear wall.

11. The arc chamber according to claim 1, wherein said polar expansions are made of a material chosen from the group made up of low-carbon sintered steel, low-carbon rolled steel, passivated pure iron, PBMs.

12. A unipolar or multipolar switching device for low-voltage systems, comprising:
an external casing;
at least one pair of contacts comprising a mobile contact that can be coupled to and uncoupled from a corresponding fixed contact;
a control device for opening and closing said at least one pair of contacts; and
a protection device operatively connected to said control device,
said switching device being characterized in that it comprises a housing cavity, inserted in which is an arc chamber according to claim 1.

13. The switching device according to claim 12, wherein said external casing comprises a first shell and a second shell, which fit together through removable connection means, said first shell housing said control device, said device comprising a moving element, on which a mobile contact is mounted, said moving element being housed within said second shell and being actuated by said control device between at least two characteristic positions, which define a condition of device open and device closed.

14. The switching device according to claim 13, wherein it comprises for each pole a first pair of contacts and a second pair of contacts that can be coupled to and uncoupled from one another, said device comprising a pair of arc chambers according to claim 1, said arc chambers being set in mutually opposite positions with respect to the axis of rotation of said moving element.

15. The switching device according to claim 14, wherein that a first arc chamber can be inserted in a corresponding cavity through a first side of said second shell, a second arc chamber being inserted in the corresponding cavity through a second side of said second shell opposite to said first side.

16. The switching device according to claim 15, wherein said second side of said second shell comprises a removable covering element, which that enables access to said arc chamber and can be inserted from said second side.

17. The arc chamber according to claim 2, wherein said containment seats are made of a single piece with said casing.

18. The arc chamber according to claim 3, wherein said containment seats are made of a single piece with said casing.

19. The arc chamber according to claim 4, wherein said containment seats are made of a single piece with said casing.

20. The arc chamber according to claim 5, wherein said containment seats are made of a single piece with said casing.
